(19) United States
(12) Patent Application Publication
(10) Pub. No.: US 2015/0085243 A1
(43) Pub. Date: Mar. 26, 2015

(54) ARM OF SPECTACLES

(71) Applicant: GAZELLE CORPORATION, Taipei City (TW)

(72) Inventor: Shang-Tai WU, Taipei City (TW)

(73) Assignee: GAZELLE CORPORATION, Taipei City (TW)

(21) Appl. No.: 14/035,008

(22) Filed: Sep. 24, 2013

(51) Int. Cl. G02C 5/20; G02C 5/16

(52) U.S. Cl. CPC G02C 5/20; G02C 5/16
USPC 351/114; 351/118

(57) ABSTRACT

An arm (1) of spectacles (8) having a frame member (81) includes an arm rod (10) and an adjustable hanging assembly (20). The adjustable hanging assembly (20) comprises a hanging part (21) connected to the arm rod (10) and a positioning member (22) disposed between the arm rod (10) and the hanging part (21). Thus, the comfort of a user wearing spectacles can be improved.

### BACKGROUND OF THE INVENTION

1. Field of the Invention

The present invention relates to spectacles and in particular to an arm of spectacles.

2. Description of Related Art

Due to contemporary people's hard work and excessive use of eyes, they overloaded their eyes in poor sight consequently and cannot clearly see the environment and surrounding objects. Therefore, corrective spectacles are developed to be worn on the head of a user such that the corrective lens can be matched to the eyes of the user in order that the user can clearly see the environment and surrounding objects through the corrective lens to achieve the effect of sight correction.

The traditional spectacles mainly comprise a frame, a pair of arms, and a pair of corrective lenses. Each corrective lens which corresponds to the eye is installed in the frame. One end of each arm is connected to the frame and each of the arms is spaced arranged. The end of each arm away from the frame has a hook portion. Thus, the spectacles are placed on the head of the user by the hook portion hooking the ear such that the spectacles can be retained firmly on the head of the user.

However, the traditional spectacles suffer from the follow disadvantages. Because the distance between the hook portion of the arm and the frame is not adjustable, the gap between the hook portion and the ear is likely to be excessive for a smaller head. Consequently, the hook portion can not hook the ear firmly and then the spectacles are liable to become loose and fall off. In contrast, for a bigger head, an excessive force is exerted when the hook portion hooks the ear, resulting in the spectacles in a tight wearing condition and the user's head suffering uncomfortable feeling.

### SUMMARY OF THE INVENTION

One objective of the present invention is to provide an arm of spectacles, which changes the distance between the hanging part and the frame member to improve the comfort of a user wearing spectacles.

To achieve the above objective, the present invention provides an arm of spectacles having a frame member. The arm comprises an arm rod and an adjustable hanging assembly; one end of the arm rod is connected to the frame member; the adjustable hanging assembly comprises a hanging part connected to the arm rod and a positioning member disposed between the arm rod and the hanging part.

The present invention also has the following effects. By means of the design of a bump which is disposed on the sliding bushing and can be latched and positioned to a gear rack of the arm rod, the effect of positioning can be achieved to prevent the sliding bushing from sliding accidently.

### BRIEF DESCRIPTION OF DRAWING

FIG. 1 is a perspective view of the first embodiment of the present invention;

FIG. 2 is a schematic of the first embodiment of the present invention;

FIG. 3 is the first view of the first embodiment of the present invention in a state of use;

FIG. 4 is the second view of the first embodiment of the present invention in a state of use;

FIG. 5 is the third view of the first embodiment of the present invention in a state of use;

FIG. 6 is a perspective view of the second embodiment of the present invention;

FIG. 7 is the first view of the second embodiment of the present invention in a state of use; and

FIG. 8 is the second view of the second embodiment of the present invention in a state of use.

### DETAILED DESCRIPTION OF THE INVENTION

The detailed description and technical contents regarding the present invention are explained as follows, accompanied with the attached figures. However, the attached figures are only used for reference and explanation, not to limit the present invention.

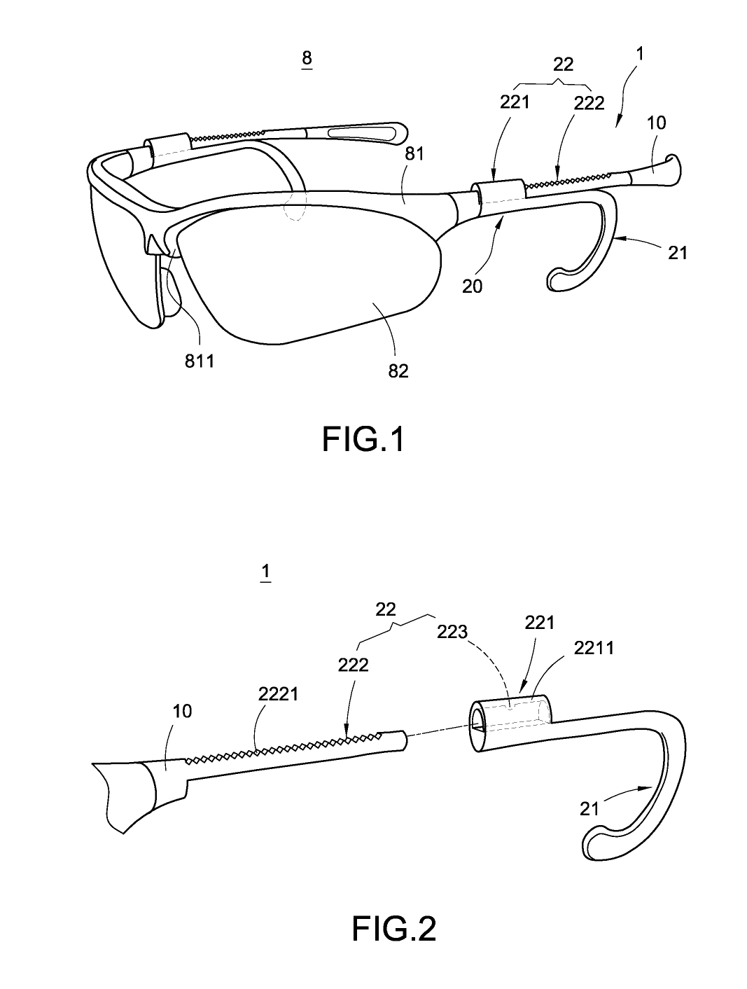

Please refer to FIGS. 1 and 2, which are the perspective view and the schematic of the first embodiment of the present invention, respectively. The present invention provides an arm 1 of spectacles 8. The arm 1 mainly comprises an arm rod 10 and an adjustable hanging assembly 20.

The spectacle 8 has a frame member 81 and a pair of arms 1; the frame member 81 has a pair of mounting portions 811 which make two spectacle glasses 82 installed in the mounting portions 811.

Each of the arms 1 comprises an arm rod 10 and an adjustable hanging assembly 20.

Each of the arm rods 10 has one end thereof connected to the frame member 81. The arm rods (10) are spaced arranged and in parallel with each other.

Each of the adjustable hanging assemblies 20 comprises a hanging part 21 and a positioning member 22 comprising a sliding bushing 221, a gear rack 222, and a bump 223.

Each sliding bushing 221 has a connecting hole 2211; each sliding bushing 221 is slidingly connected to and sleeved around the outside of the corresponding arm rod 10 such that each arm rod 10 passes through and connects in the corresponding connecting hole 2211 of the sliding bushing 221.

Each of the hanging parts 21 extends from a side peripheral surface of the corresponding sliding bushing 221 and has a fishhook shape, in which when each sliding bushing 221 slides along the corresponding arm rod 10, it is able to drive the hanging part 21 to move along the corresponding arm rod 10 to adjust the distance between each hanging parts 21 and the frame member 81.

Each of the gear rack 222 is formed on the corresponding arm rod 10 and comprises a plurality of teeth 2221 spaced arranged; each of the teeth 2221 has a triangle shape; each bump 223 is projected from an inner perimeter of the corresponding connecting hole 2211 and is disposed corresponding to the respective teeth 2221 of the corresponding gear rack 222; each bump 223 and any teeth 2221 of the corresponding gear rack 222 can be latched and positioned to each other; each bump 223 has a triangle shape.

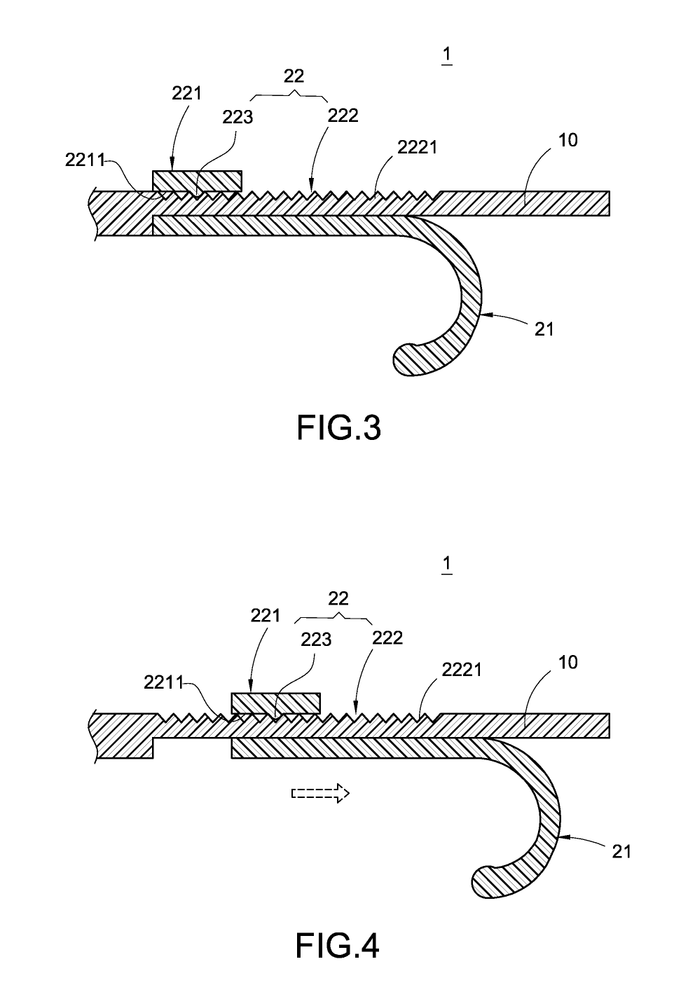

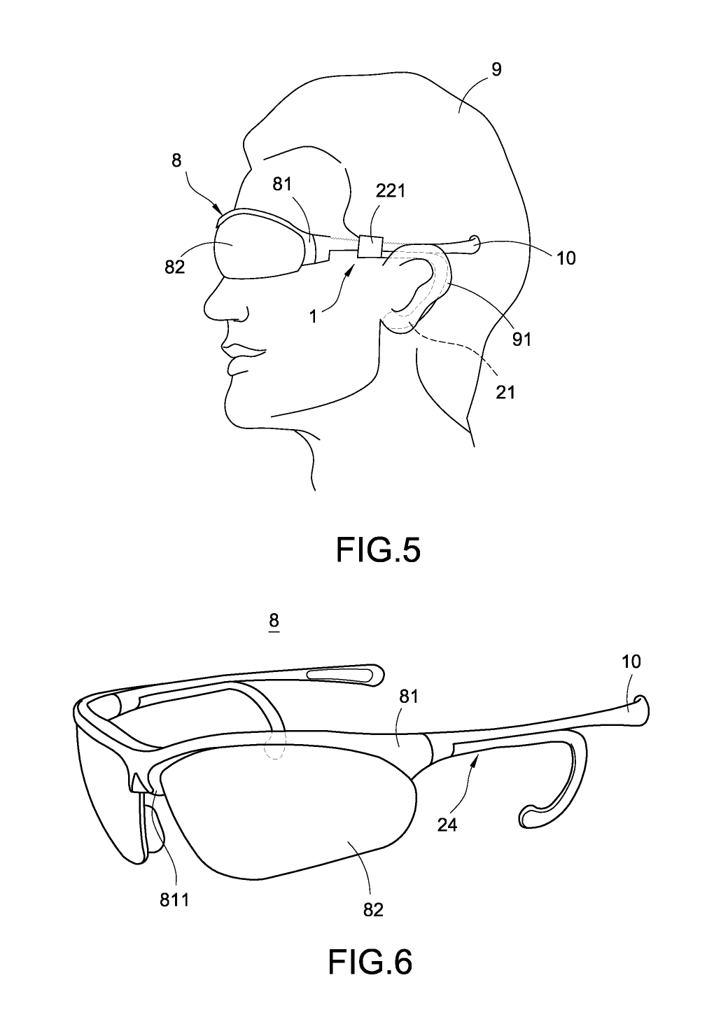

Please refer to FIGS. 3-5, which are the first, second, and third views of the first embodiment of the present invention in a state of use, respectively. In operation, the distance between each hanging part 21 and the frame member 81 is adjusted in response to the size of the user's head 9. Therefore, when the size of the user's head 9 is smaller, the sliding bushing 221 is slid along the corresponding arm rod 10 toward the frame member 81 such that each hanging part 21 moves toward the frame member 81 to decrease the distance between each hanging part 21 and the frame member 81 such that no excessive gap appears between each hanging part 21 and the frame member 81 during the user wearing the spectacles 8. Thus, the frame member 81 can be retained firmly on the head 9 and will not become loose and fall off.

In addition, when the size of the user's head 9 is bigger, the sliding bushing 221 can be moved away from the frame member 81 such that each hanging part 21 moves toward the arm rod 10 to increase the distance between each hanging part 21 and the frame member 81. Consequently, the distance between each hanging part 21 and the frame member 81 is not too short during the user wearing the spectacles 8 to cause each hanging part 21 to hook the corresponding ear 91 extremely tight. Thus, the comfort of the head 9 can be improved during the user wearing the spectacles 8.

By this means, after the distance between each hanging part 21 and the frame member 81 is adjusted well, the spectacles 8 are worn on the user's head 9. Further, each hanging part 21 hooks the corresponding ear 91 firmly to achieve the effect of attaching the spectacles 8 on the head 9 firmly. This also avoids the uncomfortable feeling of tightness or looseness, and further improves the comfort of the head 9 of the user wearing the spectacles 8.

Further, by means of the design of the bump 223 which is disposed on each sliding bushing 221 and can be latched and positioned to the gear rack 222 of each arm rod 10, when each sliding bushing 221 slides to a proper position, the effect of positioning can be achieved by the latching between each bump 223 and the corresponding gear rack 222 to prevent the sliding bushing 221 from sliding accidently and thus, the convenience and comfort of the user is improved.

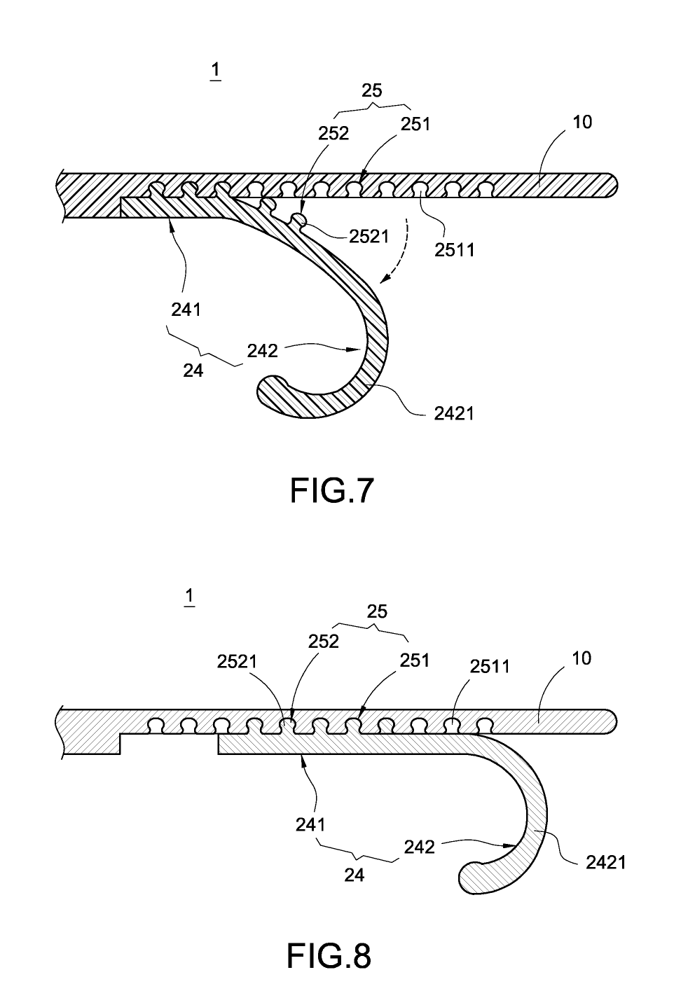

Please refer to FIGS. 6-8, which are the perspective view, the first view in a state of use, and the second view in a state of use of the second embodiment of the present invention, respectively. The main difference between these two embodiments is that in the second embodiment, each hanging part 21 is replaced with the hanging part 24 and each positioning member 22 is replaced with the positioning member 25.

Each of the hanging parts 24 comprises a fixed segment 241 and a free segment 242 extending from the fixed segment 241; one end of each free segment 242 away from the corresponding fixed segment 241 has a hook portion 2421; the segment between each fixed segment 241 and the corresponding free segment 242 has a fishhook shape; each hanging part 24 is a flexible member.

Each of the positioning members 25 comprises a plurality of female units 251 and a plurality of male units 252; each of the female units 251 is engaged with the corresponding male unit 252; each male unit 252 is a respective protrusion 2521 projected from the fixed segment 241; the respective protrusion 2521 can be inserted into and fixed in the corresponding recess 2511; the recesses 2511 are spaced arranged and the protrusions 2521 are spaced arranged, in which each female unit 251 is engaged with the corresponding male unit along the corresponding arm rod 10 such that the free segment 242 generates a hook portion 2421 of various shapes.

In operation, when the size of the user's head 9 is smaller, some protrusions 2521 are detached from the recesses 2511 along the corresponding arm rod 10 toward the frame member 81 such that each free segment 242 extends toward the frame member 81 and extends away from the arm rod 10 to change the shape of the corresponding hook portion 2421 and decrease the distance between the hook portion 2421 of each free segment 242 and the frame member 81. Therefore, no excessive gap appears between the hook portion 2421 of each free segment 242 and the corresponding ear 91 during the user wearing the spectacles 8 and the frame member 81 can be retained firmly on the head 9 and will not become loose and fall off.

In addition, when the size of the user's head 9 is bigger, some protrusions 2521 away from the frame member 81 can be inserted into and fixed in some recesses 2511, which are located away from the frame member 81, along the corresponding arm rod 10 away from the frame member 81 such that each free segment 242 is attached to the corresponding arm rod 10 and moves away from the frame member 81 to change the shape of the corresponding hook portion 2421 and also the distance between the hook portion 2421 of each free segment 242 and the frame member 81 is increased. As a result, the distance between each hook portion 2421 and the frame member 81 is not too short during the user wearing the spectacles 8 to cause each hook portion 2421 to hook the corresponding ear 91 extremely tight. Thus, the comfort of the head 9 can be improved during the user wearing the spectacles 8 and the comfort of the user wearing the spectacles 8 can be enhanced.

Besides, each protrusion 2521 inserted into and fixed in the corresponding recess 2511 can achieve the effect of positioning to prevent the hanging part 24 from detaching from the arm rod 10 to further improve the convenience and comfort of the user's operation.

In summary, the arm of the spectacles of the present invention is indeed useful, novel and non-obvious. Also, the structure of the present invention has not been anticipated by similar products and has not been used in public, which meet the requirement of patent application. Please examine the application carefully and grant it a patent for protecting the rights of the inventor.

What is claimed is:

1. An arm (1) of spectacles (8) having a frame member (81), the arm (1) comprising:
an arm rod (10) having one end thereof connected to the frame member (81); and
an adjustable hanging assembly (20) comprising a hanging part (21) connected to the arm rod (10) and a positioning member (22) disposed between the arm rod (10) and the hanging part (21).

2. The arm (1) of the spectacles (8) according to claim 1, wherein the positioning member (22) comprises a sliding bushing (221) sleeved around the outside of the arm rod (10) and extending from a side peripheral surface of the sliding bushing (221), wherein the sliding bushing (221) is able to drive the hanging part (21) to move along the arm rod (10).

3. The arm (1) of the spectacles (8) according to claim 2, wherein the positioning member (22) further comprises a gear rack (222) and a bump (223), the sliding bushing (221) has a connecting hole (2211), the arm rod (10) passes through and connects in the connecting hole (2211), the gear rack (222) is formed on the arm rod (10) and the bump (223) is projected from an inner perimeter of the connecting hole (2211), and the bump (223) and the gear rack (222) are latched and positioned to each other.

4. The arm (1) of the spectacles (8) according to claim 3, wherein the gear rack (222) comprises a plurality of teeth (2221) spaced arranged, and the bump (223) can be latched and positioned to any of the teeth (2221).

5. The arm (1) of the spectacles (8) according to claim 4, wherein the teeth (2221) and the bump (223) both have a triangle shape.

6. The arm (1) of the spectacles (8) according to claim 1, wherein the hanging part (24) has a fixed segment (241) and a free segment (242) extending from the fixed segment (241), the positioning member (25) comprises a plurality of female units (251) of the arm rod (10) and a plurality of male units (252) disposed on the fixed segment (241), and each of the female units (251) is engaged with the corresponding male unit (252) along the arm rod (10) such that the free segment (242) generates a hook portion (2421) of various shapes.

7. The arm (1) of the spectacles (8) according to claim 6, wherein each female unit (251) is formed in a respective recess (2511) and each male unit (252) is a respective protrusion (2521) projected from the fixed segment (241), and the respective protrusion (2521) can be inserted into and fixed in the corresponding recess (2511).

8. The arm (1) of the spectacles (8) according to claim 7, wherein the recesses (2511) are spaced arranged and the protrusions (2521) are spaced arranged.

9. The arm (1) of the spectacles (8) according to claim 6, wherein the hanging part (21, 24) is a flexible member.

10. The arm (1) of the spectacles (8) according to claim 1, wherein the hanging part (21, 24) has a fishhook shape.
